(19) United States
(12) Patent Application Publication
(10) Pub. No.: US 2018/0137498 A1
(43) Pub. Date: May 17, 2018

(54) PAYMENT METHOD USING AGENT DEVICE AND ELECTRONIC DEVICE FOR PERFORMING THE SAME

(71) Applicant: Samsung Electronics Co., Ltd., Gyeonggi-do (KR)

(72) Inventors: Kyung Duk KIM, Seoul (KR); Jong In PARK, Seoul (KR); Seung Doo CHOI, Gyeonggi-do (KR)

(73) Assignee: Samsung Electronics Co., Ltd.

(21) Appl. No.: 15/815,050

(22) Filed: Nov. 16, 2017

(30) Foreign Application Priority Data
Nov. 16, 2016 (KR) 10-2016-0152775

(51) Int. Cl. G06Q 20/32; H04W 4/00; G06Q 20/34; G06Q 20/36

(52) U.S. Cl. CPC G06Q 20/3278; H04W 4/005; G06Q 20/3674; G06Q 20/352; G06Q 20/3227

(57) ABSTRACT

A payment method is provided that includes transmitting card information and identification information of a second device to a server, by a first device, transmitting payment data corresponding to the card information to the second device specified by the identification information, by the server, and performing a payment transaction with an external device by using the payment data, by the second device.

### PRIORITY

This application claims priority under 35 U.S.C. § 119(a) to Korean Patent Application Serial No. 10-2016-0152775, which was filed in the Korean Intellectual Property Office on Nov. 16, 2016, the entire content of which is incorporated herein by reference.

### BACKGROUND

### 1. Field of the Disclosure

The present disclosure relates generally to a payment method using an agent device and an electronic device for performing the same.

### 2. Description of the Related Art

With the development of information technology (IT), electronic devices have rapidly added functionality for the users. The electronic devices may provide multimedia services (e.g., music streaming services, video streaming services, or digital broadcasting services) or network-based communication services (e.g., voice communication, wireless Internet, short message services (SMSs), and multimedia messaging services (MMSs)).

In recent years, Fintech, in which a finance technique and IT are combined, has been spotlighted. Fintech, which may be viewed as switching from a financial paradigm, is being expanded to financial and payment services that are offline, and the development of financial and payment platforms, as well as to conventional online financial services.

Electronic device manufacturers are cooperating with credit card companies and banks to construct mobile payment platforms and distributed mobile payment services.

For mobile payment services, various contactless payment modules (e.g., near field communication (NFC) modules and magnetic stripe transmission (MST) modules) are mounted on the electronic devices. However, many users still use electronic devices that have no contactless payment module. The situation obstructs wide distribution and adaptation of mobile payment services.

### SUMMARY

An aspect of the present disclosure provides a method for allowing a mobile payment service of a principal device, which is an electronic device on which a contactless payment module is not mounted, by utilizing an agent device, which is an electronic device on which a contactless payment module is mounted.

In accordance with an aspect of the present disclosure, there is provided an electronic device including a communication circuit; a contactless payment module; a processor electrically connected to the communication circuit and the contactless payment module; and a memory electrically connected to the processor. The memory stores instructions to cause the processor to receive payment data originating from another electronic device through the communication circuit; and transmit the payment data to an external device through the contactless payment module.

In accordance with an aspect of the present disclosure, there is provided a payment method including transmitting card information and identification information of a second device to the server by the first device; transmitting the payment data corresponding to the card information to the second device specified by the identification information by the server; and performing a payment transaction with an external device by using the payment data by the second device.

In accordance with another aspect of the present disclosure, there is provided a payment method including receiving payment data corresponding to card information from a server by a first device; transmitting identification information of a second device to the server by the first device; performing an authentication procedure based on an interaction between the first device and the second device by the server; if the authentication procedure is successful, transmitting an authentication success message to the first device and the second device by the server; if the authentication success message is received, transmitting the payment data to the second device by the first device; and performing a payment transaction with an external device by using the payment data by the second device.

### BRIEF DESCRIPTION OF THE DRAWINGS

The above and other aspects, features, and advantages of embodiments of the present disclosure will be more apparent from the following description taken in conjunction with the accompanying drawings, in which:

FIG. 1 illustrates an electronic device according to an embodiment of the present disclosure;

FIG. 2 illustrates an electronic device according to an embodiment of the present disclosure;

FIG. 3 a program module according to an embodiment of the present disclosure;

FIG. 4A illustrates an environment in which payment transactions according to an embodiment of the present disclosure are made;

FIG. 4B is a view illustrating payment data according to an embodiment of the present disclosure;

FIG. 5 illustrates an electronic device according to an embodiment of the present disclosure;

FIG. 6 is a sequence diagram illustrating a payment method in which payment data is provided by a server and an authentication procedure is made by the server according to an embodiment of the present disclosure;

FIG. 7 is a sequence diagram illustrating a payment method in which payment data is provided by a server and an authentication procedure is made by a first electronic device according to an embodiment of the present disclosure;

FIG. 8 is a sequence diagram illustrating a payment method in which payment data is provided by a first electronic device and an authentication procedure is made by a server according to an embodiment of the present disclosure; and

FIG. 9 is a sequence diagram illustrating a payment method in which payment data is provided by a first electronic device and an authentication procedure is made by the first electronic device according to an embodiment of the present disclosure.

Throughout the drawings, like reference numbers may be used to depict the same or similar elements, features, and structures.

### DETAILED DESCRIPTION

Those of ordinary skill in the art will recognize that modifications, equivalents, and/or alternatives on the various embodiments described herein can be made without departing from the scope and spirit of the present disclosure.

In the present disclosure, the expressions “have”, “may have”, “include”, “comprise”, “may include”, and “may comprise” used herein indicate existence of corresponding features (e.g., elements such as numeric values, functions, operations, or components) but do not exclude presence of additional features.

In the present disclosure, the expressions “A or B”, “at least one of A and/or B”, or “one or more of A and/or B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

Terms such as “first”, “second”, and the like used in the present disclosure may be used to refer to various elements regardless of the order and/or the priority, and to distinguish the relevant elements from other elements, but do not limit the elements. For example, “a first user device” and “a second user device” indicate different user devices regardless of the order or priority. For example, without departing from the scope of the present disclosure, a first element may be referred to as a second element, and similarly, a second element may be referred to as a first element.

It is understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

The expression “configured to” used in the present disclosure may be used interchangeably with the expressions “suitable for”, “having the capacity to”, “designed is to”, “adapted to”, “made to”, or “capable of”. The term “configured to” does not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs which are stored in a memory device.

Terms used in the present disclosure are used to describe specific embodiments and are not intended to limit the scope of this disclosure. The terms of a singular form may include plural forms unless otherwise specified. All the terms used herein, which include technical or scientific terms, may have the same meaning that is generally understood by a person skilled in the art. It is further understood that terms, which are defined in a dictionary and commonly used, should also be interpreted as is customary in the relevant related art and not in an idealized or overly formal unless expressly so defined in various embodiments of the present disclosure. In some cases, even if terms are defined in the present disclosure, they may not be interpreted to exclude embodiments of the present disclosure.

An electronic device according to various embodiments of the present disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. The wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments of the present disclosure, the electronic device may be a home appliance. The home appliances may include at least one of, for example, televisions (TVs), digital versatile disc (DVD) players, audio players and recorders, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to an embodiment of the present disclosure, an electronic device may include at least one of various medical devices (e.g., portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, global navigation satellite system (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller machines (ATMs), points of sales (POSs) devices, or Internet of things (IoT) devices (e.g., light bulbs, various sensors, electric or gas meters, sprinkler devices, fire alarms, thermostats, street lamps, toasters, exercise equipment, hot water tanks, heaters, boilers, and the like).

According to an embodiment of the present disclosure, the electronic device may include at least one of parts of furniture or buildings/structures, electronic boards, electronic signature receiving devices, projectors, or various measuring instruments (e.g., water meters, electricity meters, gas meters, or wave meters, and the like). The electronic device may be one of the above-described devices or a combination thereof. An electronic device may be a flexible electronic device. Furthermore, an electronic device of the present disclosure may not be limited to the above-described electronic devices and may include other electronic devices and new electronic devices according to the development of new technologies.

In the present disclosure, the term “user” may refer to a person who uses an electronic device or may refer to a device (e.g., an artificial intelligence electronic device) that uses the electronic device.

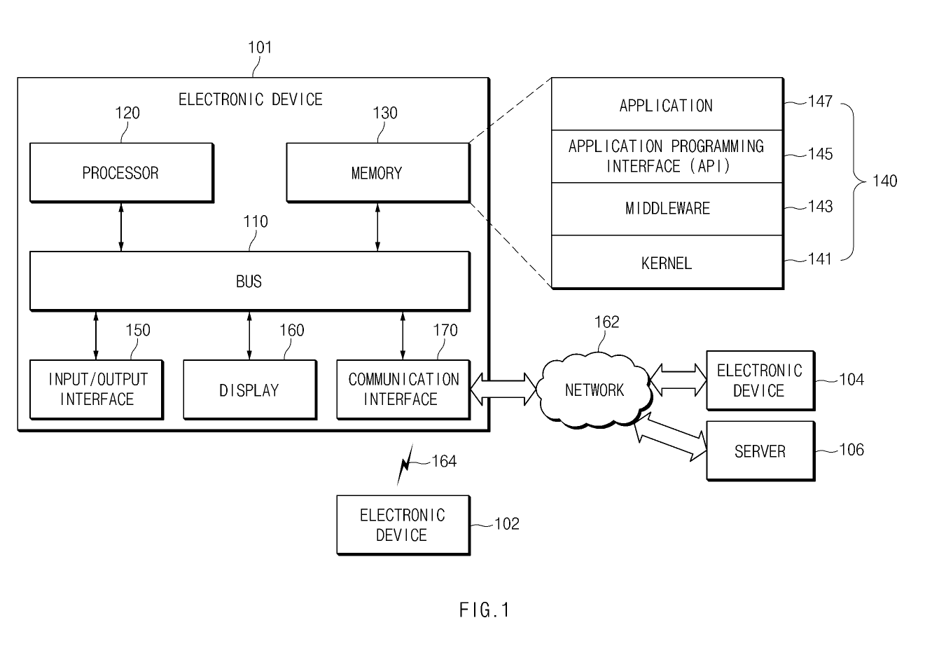

FIG. 1 illustrates an electronic device in a network environment according to an embodiment of the present disclosure.

Referring to FIG. 1, according to various embodiments of the present disclosure, an electronic device 101, electronic device 102, electronic device 104, and a server 106 may be connected with each other over a network 162 or local wireless communication 164. The electronic device 101 may include a bus 110, a processor 120, a memory 130, an input/output (I/O) interface 150, a display 160, and a communication interface 170. The electronic device 101 may not include at least one of the above-described elements or may further include other element(s).

The bus 110 may interconnect the above-described elements 120 to 170 and may include a circuit for conveying communications (e.g., a control message and/or data) among the above-described elements.

The processor 120 may include one or more of a CPU, AP, or a communication processor (CP). For example, the processor 120 may perform an arithmetic operation or data processing associated with control and/or communication of at least other elements of the electronic device 101.

The memory 130 may include a volatile and/or nonvolatile memory. For example, the memory 130 may store instructions or data associated with at least one other element(s) of the electronic device 101. According to an embodiment of the present disclosure, the memory 130 may store software and/or a program 140. The program 140 may include, for example, a kernel 141, a middleware 143, an application programming interface (API) 145, and/or applications147. At least a part of the kernel 141, the middleware 143, or the API 145 may be referred to as an operating system (OS).

For example, the kernel 141 may control or manage system resources (e.g., the bus 110, the processor 120, the memory 130, and the like) that are used to execute operations or functions of other programs (e.g., the middleware 143, the API 145, and the applications 147). Furthermore, the kernel 141 may provide an interface that allows the middleware 143, the API 145, or the applications 147 to access discrete elements of the electronic device 101 to control or manage system resources.

The middleware 143 may perform, for example, a mediation role such that the API 145 or the applications 147 communicates with the kernel 141 to exchange data.

Furthermore, the middleware 143 may process one or more task requests received from the applications 147 according to an assigned priority. For example, the middleware 143 may assign the priority, which makes it possible to use a system resource (e.g., the bus 110, the processor 120, the memory 130, or the like) of the electronic device 101, to at least one of the applications 147. For example, the middleware 143 may process one or more task requests according to the priority assigned to at least one of the tasks, which makes it possible to perform scheduling or load balancing on one or more task requests.

The API 145 may be, for example, an interface through which the applications 147 controls a function provided by the kernel 141 or the middleware 143, and may include, for example, at least one interface or function (e.g., an instruction) for a file control, a window control, image processing, a character control, or the like.

The input/output interface 150 may play a role, for example, transmitting an instruction or data input from a user or another external device to other element(s) of the electronic device 101. Furthermore, the input/output interface 150 may output an instruction or data, received from other element(s) of the electronic device 101 to a user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a part of a user's body.

The communication interface 170 may establish communication between the electronic device 101 and an external device (e.g., the first external electronic device 102, the second external electronic device 104, or the server 106). For example, the communication interface 170 may be connected to the network 162 over wireless communication or wired communication to communicate with the external device.

The wireless communication may include cellular communication using at least one of, for example, long-term evolution (LTE), LTE Advanced (LTE-A), code division multiple access (CDMA), wideband CDMA (WCDMA), universal mobile telecommunications system (UMTS), wireless broadband (WiBro), global system for mobile communications (GSM), or the like, as a cellular communication protocol. According to an embodiment of the present disclosure, the wireless communication may include at least one of wireless fidelity (Wi-Fi), Bluetooth™, Bluetooth low energy (BLE), Zigbee, near NFC, magnetic secure transmission, magnetic stripe transmission, radio frequency, a body area network (BAN), a GNSS, or the like.

The magnetic secure transmission or the magnetic stripe transmission may generate a pulse in response to the transmission of data, and the pulse may generate a magnetic field signal. The electronic device 101 may transfer the magnetic field signal to a POS device. The POS device may detect the magnetic field signal using a magnetic stripe reader or a magnetic secure reader, and may recover the data by converting the detected magnetic field signal to an electrical signal. In the present disclosure, “MST” may mean magnetic secure transmission or magnetic stripe transmission.

The GNSS may include at least one of, for example, a global positioning system (GPS), a global navigation satellite system (Glonass), a Beidou navigation satellite system (Beidou), or an European global satellite-based navigation system (Galileo) based on an available region, a bandwidth, or the like. Hereinafter, in the present disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 162 may include at least one of telecommunications networks, for example, a computer network (e.g., LAN or WAN), an Internet, or a telephone network.

Each of the first and second external electronic devices 102 and 104 may be a device of which the type is different from or the same as that of the electronic device 101. According to an embodiment of the present disclosure, the server 106 may include a group of one or more servers.

According to various embodiments of the present disclosure, the server 106 may include a mobile payment service server for realizing a mobile payment service in the electronic device 101, and/or a payment server of a card company and/or a financial institution. For example, the mobile payment service server may include a server (e.g., a token service provider (TSP) server) that manages a token related to a payment application. Further, for example, a payment server of a card company and/or a financial institution may include a server (e.g., a trusted service manager (TSM) server) that manages a financial account of the user.

According to an embodiment of the present disclosure, the mobile payment service server may interact with the payment server of the card company and/or a financial institution to provide payment information, which may be referenced as payment data (e.g., a one-time token (OTT)), to the electronic device 101 for each payment transaction. The electronic device 101 may transmit the provided payment information to an external device 102 and 104 (e.g., a POS terminal) through various channels (e.g., an MST channel and an NFC channel) via a designated security authentication. The external device 102 and 104 may in turn transmit the payment information to the payment server of the card company and/or a financial institution and may complete the corresponding payment transaction by obtaining a payment approval.

According to an embodiment of the present disclosure, the security authentication policy applied to various payment cards may be determined by a card company and/or a financial institution (e.g., a card issuer). The information or data including the security authentication policy of the various payment cards may be delivered to the electronic device 101 by the mobile payment service server and/or the server of the card company and/or a financial institution.

According to various embodiments of the present disclosure of the present disclosure, all or some of the operations executed by the electronic device 101 may be executed by another or a plurality of electronic devices (e.g., the electronic devices 102 and 104, or the server 106). When the electronic device 101 executes some functions or services automatically or upon request, it may request at least some functions associated with the functions or services from another device (102, 104, or 106), in place of or in addition to directly executing the functions or services. The other electronic device may execute a requested function or an additional function, and may transfer the result to the electronic device 101. The electronic device 101 may process the received result directly or additionally, and may provide a requested function or service. To this end cloud computing, distributed computing, or client-server computing technologies may be used.

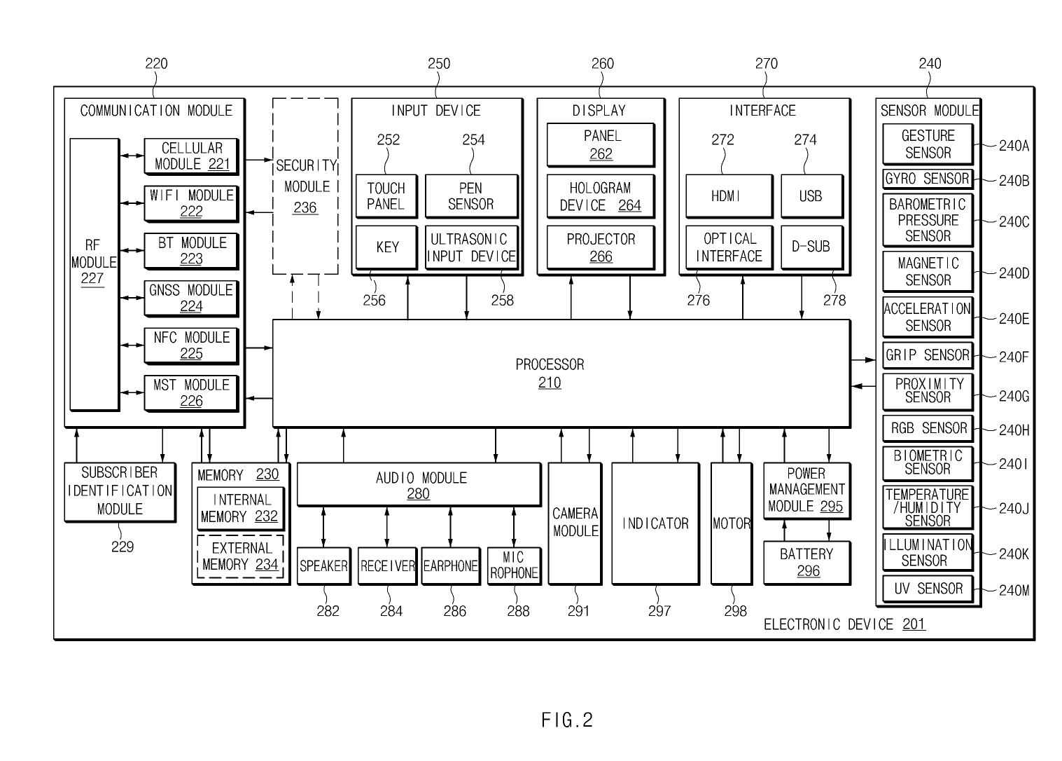

FIG. 2 illustrates an electronic device according to an embodiment of the present disclosure.

Referring to FIG. 2, an electronic device 201 may include, for example, all or a part of the electronic device 101. The electronic device 201 may include one or more processors (e.g., an AP) 210, a communication module 220, a subscriber identification module (SIM) 229, a memory 230, a sensor module 240, an input device 250, a display 260, an interface 270, an audio module 280, a camera module 291, a power management module 295, a battery 296, an indicator 297, and a motor 298.

The processor 210 may drive, for example, an OS or an application to control a plurality of hardware or software elements connected to the processor 210, and may process and compute a variety of data. For example, the processor 210 may be implemented with a system on chip (SoC). According to an embodiment of the present disclosure, the processor 210 may further include a graphic processing unit (GPU) and/or an image signal processor (ISP). The processor 210 may include at least a part (e.g., a cellular module 221) of elements illustrated in FIG. 2. The processor 210 may load an instruction or data, which is received from at least one of other elements (e.g., a nonvolatile memory), into a volatile memory and process the loaded instruction or data. The processor 210 may store a variety of data in the nonvolatile memory.

The communication module 220 may be configured the same as or similar to the communication interface 170. The communication module 220 may include the cellular module 221, a Wi-Fi module 222, a Bluetooth (BT) module 223, a GNSS module 224 (e.g., a GPS module, a Glonass module, a Beidou module, or a Galileo module), a NFC module 225, a MST module 226, and a radio frequency (RF) module 227.

The cellular module 221 may provide, for example, voice communication, video communication, a character service, an Internet service, or the like over a communication network. According to an embodiment of the present disclosure, the cellular module 221 may perform discrimination and authentication of the electronic device 201 within a communication network by using the SIM (e.g., a SIM card) 229. The cellular module 221 may perform at least a portion of functions that the processor 210 provides. The cellular module 221 may include a CP.

Each of the Wi-Fi module 222, the BT module 223, the GNSS module 224, the NFC module 225, or the MST module 226 may include a processor for processing data exchanged through a corresponding module. According to an embodiment of the present disclosure, at least a part (e.g., two or more) of the cellular module 221, the Wi-Fi module 222, the BT module 223, the GNSS module 224, the NFC module 225, or the MST module 226 may be included within one integrated circuit (IC) or an IC package.

For example, the RF module 227 may transmit and receive a communication signal (e.g., an RF signal). For example, the RF module 227 may include a transceiver, a power amplifier module (PAM), a frequency filter, a low noise amplifier (LNA), an antenna, or the like. According to an embodiment of the present disclosure, at least one of the cellular module 221, the Wi-Fi module 222, the BT module 223, the GNSS module 224, the NFC module 225, or the MST module 226 may transmit and receive an RF signal through a separate RF module.

The SIM 229 may include, for example, a card and/or embedded SIM that includes a SIM, and may include unique identify information (e.g., integrated circuit card identifier (ICCID)) or subscriber information (e.g., international mobile subscriber identity (IMSI)).

The memory 230 may include an internal memory 232 or an external memory 234. The internal memory 232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 234 may include a flash drive such as compact flash (CF), secure digital (SD), micro secure digital (Micro-SD), mini secure digital (Mini-SD), extreme digital (xD), a multimedia card (MMC), a memory stick, or the like. The external memory 234 may be operatively and/or physically connected to the electronic device 201 through various interfaces.

A security module 236 may include a storage space of which a security level is higher than that of the memory 230 and may be a circuit that guarantees safe data storage and a protected execution environment. The security module 236 may be implemented with a separate circuit and may include a separate processor. For example, the security module 236 may be in a smart chip or a SD card, which is removable, or may include an embedded secure element (eSE) embedded in a fixed chip of the electronic device 201. Furthermore, the security module 236 may operate based on an OS that is different from the OS of the electronic device 201. For example, the security module 236 may operate based on a java card open platform (JCOP) OS.

The sensor module 240 may measure, for example, a physical quantity or may detect an operation state of the electronic device 201. The sensor module 240 may convert the measured or detected information to an electric signal. The sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H (e.g., red, green, blue (RGB) sensor), a biometric sensor 240I, a temperature/humidity sensor 240J, an illuminance sensor 240K, or an UV sensor 240M. Additionally or generally, the sensor module 240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment of the present disclosure, the electronic device 201 may further include a processor that is a part of the processor 210 or independent of the processor 210, and is configured to control the sensor module 240. The processor may control the sensor module 240 while the processor 210 remains at a sleep state.

The input device 250 may include, for example, a touch panel 252, a (digital) pen sensor 254, a key 256, or an ultrasonic input unit 258. For example, the touch panel 252 may use at least one of capacitive, resistive, infrared, and ultrasonic detecting methods. Also, the touch panel 252 may further include a control circuit. The touch panel 252 may further include a tactile layer to provide a tactile reaction to a user.

The (digital) pen sensor 254 may be, for example, a part of a touch panel or may include an additional sheet for recognition. The key 256 may include, for example, a physical button, an optical key, or a keypad. The ultrasonic input device 258 may detect or sense an ultrasonic signal, which is generated from an input device, through a microphone 288 and may check data corresponding to the detected ultrasonic signal.

The display 260 may include a panel 262, a hologram device 264, or a projector 266. The panel 262 may be the same as or similar to the display 160. The panel 262 may be implemented, for example, to be flexible, transparent, or wearable. The panel 262 and the touch panel 252 may be integrated into a single module. The hologram device 264 may display a stereoscopic image in a space using a light interference phenomenon. The projector 266 may project light onto a screen so as to display an image. For example, the screen may be arranged in the inside or the outside of the electronic device 201. According to an embodiment of the present disclosure, the panel 262 may include a pressure sensor or force sensor that measures the intensity of touch pressure by a user. The pressure sensor may be implemented integrally with the touch panel 252, or may be implemented as at least one sensor separately from the touch panel 252. The display 260 may further include a control circuit for controlling the panel 262, the hologram device 264, or the projector 266.

The interface 270 may include, for example, a high-definition multimedia interface (HDMI) 272, a USB 274, an optical interface 276, or a D-subminiature (D-sub) 278. The interface 270 may be included, for example, in the communication interface 170. Additionally or generally, the interface 270 may include, for example, a mobile high definition link (MHL) interface, a SD card/multi-media card (MMC) interface, or an Infrared Data Association (IrDA) standard interface.

The audio module 280 may convert a sound and an electric signal in dual directions. At least a part of the audio module 280 may be included, for example, in the input/output interface 150. The audio module 280 may process, for example, sound information that is input or output through a speaker 282, a receiver 284, an earphone 286, or the microphone 288.

For example, the camera module 291 may shoot a still image or a video. According to an embodiment of the present disclosure, the camera module 291 may include at least one or more image sensors (e.g., a front sensor or a rear sensor), a lens, an ISP, or a flash (e.g., an LED or a xenon lamp).

The power management module 295 may manage, for example, power of the electronic device 201. According to an embodiment of the present disclosure, a power management integrated circuit (PMIC), a charger IC, or a battery gauge may be included in the power management module 295. The PMIC may utilize a wired charging method and/or a wireless charging method. The wireless charging method may include, for example, a magnetic resonance method, a magnetic induction method, or an electromagnetic method and may further include an additional circuit, for example, a coil loop, a resonant circuit, a rectifier, or the like. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, and the like. The motor 298 may convert an electrical signal into a mechanical vibration and may generate the following effects: vibration, haptic, and the like. A processing device (e.g., a GPU) for supporting a mobile TV may be included in the electronic device 201. The processing device for supporting the mobile TV may process media data according to the standards of digital multimedia broadcasting (DMB), digital video broadcasting (DVB), MediaFLO™, or the like.

Each of the above-mentioned elements of the electronic device according to various embodiments of the present disclosure may be configured with one or more components, and the names of the elements may be changed according to the type of the electronic device. The electronic device may include at least one of the above-mentioned elements, and some elements may be omitted or other additional elements may be added. Furthermore, some of the elements of the electronic device may be combined with each other to form one component such that the functions of the elements may be performed in the same manner as before the combination.

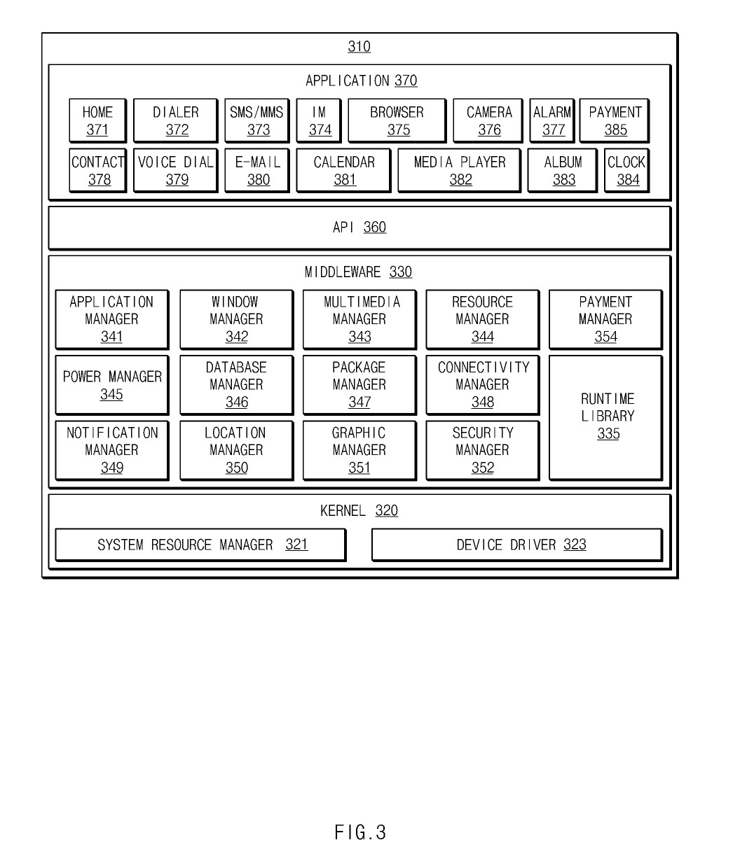

FIG. 3 illustrates a program module according to an embodiment of the present disclosure.

According to an embodiment of the present disclosure, a program module 310 may include an OS to control resources associated with an electronic device 101, and/or applications 147 driven on the OS. The OS may be, for example, Android, iOS, Windows, Symbian, Tizen, or Bada.

The program module 310 may include a kernel 320, a middleware 330, an API 360, and/or an application 370. At least a portion of the program module 310 may be preloaded on an electronic device or may be downloadable from an external electronic device.

The kernel 320 may include, for example, a system resource manager 321 or a device driver 323. The system resource manager 321 may control, allocate, or retrieve system resources. According to an embodiment of the present disclosure, the system resource manager 321 may include a process managing unit, a memory managing unit, a file system managing unit, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function that an application 370 needs, or may provide functions to the application 370 through the API 360 to allow the application 370 to efficiently use limited system resources of the electronic device. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, or a payment manager 354.

The runtime library 335 may include, for example, a library module that is used by a compiler to add a new function through a programming language while the application 370 is being executed. The runtime library 335 may perform input/output management, memory management, or capacities about arithmetic functions.

The application manager 341 may manage, for example, a life cycle of at least one application of the application 370. The window manager 342 may manage a graphic user interface (GUI) resource that is used in a screen. The multimedia manager 343 may identify a format necessary for playing diverse media files, and may perform encoding or decoding of media files by using a codec suitable for the format. The resource manager 344 may manage resources such as a storage space, memory, or source code of at least one application of the application 370.

The power manager 345 may operate, for example, with a basic input/output system (BIOS) to manage a battery or power, and may provide power information for an operation of an electronic device. The database manager 346 may generate, search for, or modify database that is to be used in at least one application of the application 370. The package manager 347 may install or update an application that is distributed in the form of a package file.

The connectivity manager 348 may manage, for example, wireless connection such as Wi-Fi or Bluetooth. The notification manager 349 may display or notify an event such as arrival message, appointment, or proximity notification in a mode that does not disturb a user. The location manager 350 may manage location information about an electronic device. The graphic manager 351 may manage a graphic effect that is provided to a user, or manage a user interface relevant thereto. The security manager 352 may provide a general security function necessary for system security, user authentication, or the like. According to an embodiment of the present disclosure, in the case where an electronic device includes a telephony function, the middleware 330 may further include a telephony manager for managing a voice or video call function of the electronic device.

The middleware 330 may include a middleware module that combines various functions of the above-described elements. The middleware 330 may provide a module specialized to each type of OS to provide the required functions. Additionally, the middleware 330 may dynamically remove a part of the preexisting elements or may add new elements thereto.

The API 360 may be, for example, a set of programming functions and may be provided with a configuration that depends on the OS type. For example, in the case where an OS is Android or iOS, it may provide one API set per platform. In the case where an OS is Tizen, it may provide two or more API sets per platform.

The application 370 may include, for example, one or more applications capable of providing functions for a home application 371, a dialer application 372, an SMS/MMS application 373, an instant message (IM) application 374, a browser application 375, a camera application 376, an alarm application 377, a contact application 378, a voice dial application 379, an e-mail application 380, a calendar application 381, a media player application 382, an album application 383, a timepiece application 384, a payment application 385, a healthcare application (e.g., measuring an exercise quantity, measuring blood sugar level, or the like), or an environment information application (e.g., information of barometric pressure, humidity, temperature, or the like).

According to an embodiment of the present disclosure, the application 370 may include an information exchanging application to support information exchange between an electronic device and an external electronic device. The information exchanging application may include, for example, a notification relay application for transmitting specific information to an external electronic device, or a device management application for managing the external electronic device.

The notification relay application may include a function of transmitting notification information, which arise from other applications (e.g., applications for SMS/MMS, e-mail, healthcare, or environmental information), to an external electronic device. Additionally, the notification relay application may receive, for example, notification information from an external electronic device and provide the notification information to a user.

The device management application may manage (e.g., install, delete, or update), is for example, at least one function (e.g., turn-on/turn-off of an external electronic device itself or a part of components, or adjustment of brightness or resolution of a display) of the external electronic device which communicates with the electronic device, an application running in the external electronic device, or a service (e.g., a call service, a message service, or the like) provided from the external electronic device.

According to an embodiment of the present disclosure, the application 370 may include an application (e.g., a healthcare application of a mobile medical device) that is assigned in accordance with an attribute of an external electronic device. The application 370 may include an application that is received from an external electronic device. The application 370 may include a preloaded application or a third party application that is downloadable from a server. The names of elements of the program module 310 may be modifiable depending on type of OS.

According to various embodiments of the present disclosure, at least a portion of the program module 310 may be implemented by software, firmware, hardware, or a combination of two or more thereof At least a portion of the program module 310 may be implemented (e.g., executed), for example, by the processor 210. At least a portion of the program module 310 may include, for example, modules, programs, routines, sets of instructions, processes, or the like for performing one or more functions.

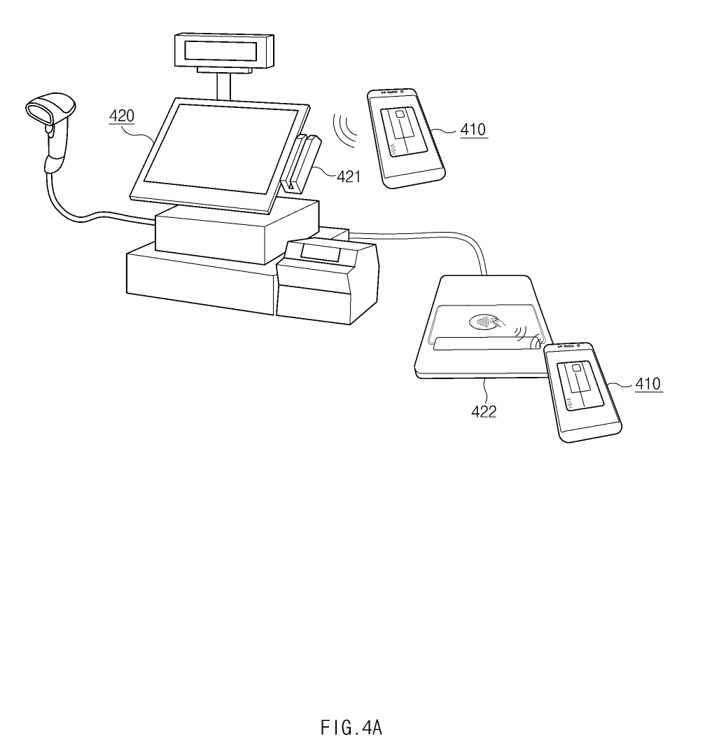

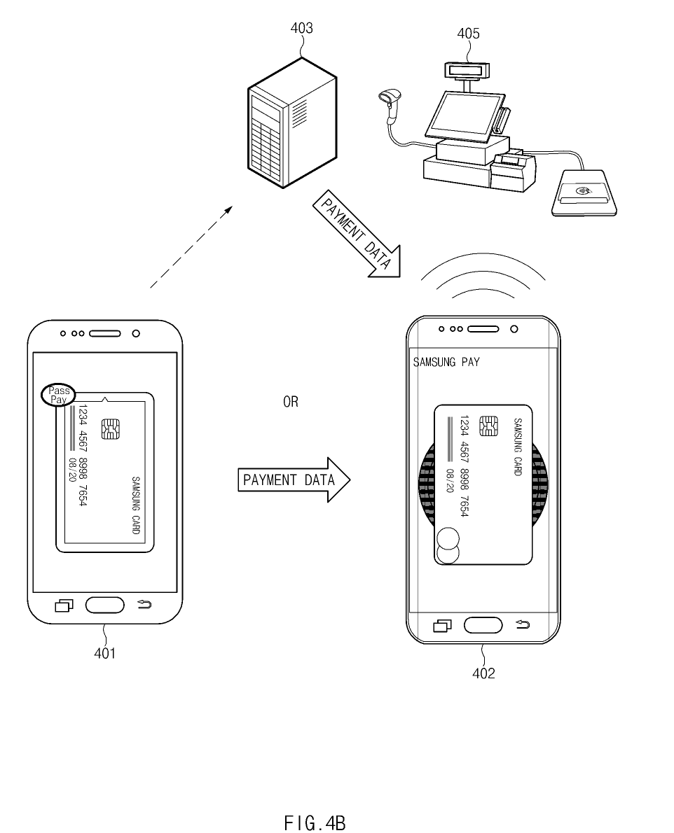

FIG. 4A illustrates an environment in which payment transactions according to various embodiments of the present disclosure are made.

Referring to FIG. 4A, an electronic device 410 according to an embodiment of the present disclosure may wirelessly interact with an external device 420. For example, the electronic device 410 may correspond to a smartphone with a contactless payment module, and the external device 420 may correspond to a POS terminal. The electronic device 410 and the external device 420, for example, may form a payment channel for a payment transaction process. The electronic device 410 may transmit and/or receive data related to payment transactions to and from the external device 420 through the formed payment channel.

According to an embodiment of the present disclosure, the electronic device 410 and the external device 420 may communicate with each other through an MST channel. For example, if the user activates an MST module coupled to or embedded in the electronic device 410, the electronic device 410 may generate and emit magnetic fields including payment data and modulated in a specific manner by using the activated MST module. Thereafter, if the electronic device 410 approaches an MST reader 421 provided in the external device 420 within a specific distance (e.g., 1 to 5 cm), the payment data may be transmitted to the external device 420 through the emitted magnetic fields.

Further, according to an embodiment of the present disclosure, the electronic device 410 and the external device 420 may communicate with each other through an NFC channel. For example, if the user activates an NFC module coupled to or embedded in the electronic device 410, the electronic device 410 may generate and emit electric fields or electromagnetic fields at a specific frequency (e.g., 13.56 MHz) including payment data by using the activated NFC module. Thereafter, if the electronic device 410 approaches an NFC reader 422 provided in the external device 420 within a specific distance (e.g., 10 cm), the payment data may be transmitted to the external device 420 through the emitted magnetic fields or electromagnetic fields.

According to an embodiment of the present disclosure, the external device 420 may complete a payment transaction based on the payment data received from the electronic device 410. For example, the external device 420 may complete a payment transaction by interacting with a mobile payment service server and/or a server of a financial institution through a network (e.g., a POS system network or the Internet).

FIG. 4B is a view illustrating payment data according to an embodiment of the present disclosure.

Referring to FIG. 4B, the payment data according to an embodiment of the present disclosure may be transmitted and received between any two of a first electronic device 401 (hereinafter, a first device), a second electronic device 402 (hereinafter, a second device), a mobile payment service server 403 (hereinafter, a server), and an external device 405 (e.g., a POS terminal). For example, the payment data may be generated by a financial institution (e.g., a credit card company or a bank), and may include at least one of a primary account number (PAN), a token, a OTT, or a cryptogram obtained by replacing at least a part of the PAN of a payment card. The payment data may include at least one of a token, a token reference ID, a part of a PAN, a PAN product ID, a token requestor ID, a token assurance level, token assurance data, an expiration date of a token, a token cryptogram, a POS entry mode, or a token requestor indicator.

According to various embodiments of the present disclosure, the second device 402 may acquire payment data originated from the first device 401 through various paths, and may perform a contactless payment transaction with the external device 405 by using the payment data.

According to an embodiment of the present disclosure, the first device 401 may receive payment data corresponding to a payment card selected by the user from the server 403. For example, the server 403 may acquire payment data by interacting with servers of card companies and/or financial institutions, and may provide the acquired payment data to the first device 401.

The first device 401 may transmit the payment data to the second device 402 through device-to-device (D2D) communication via a specific authentication procedure. For example, the D2D communication may include Bluetooth communication, infrared communication, or Wi-Fi Direct communication. The second device 402 may perform a payment transaction with the external device 405 by using the payment data received from the first device 401. For example, the second device 402 may complete the payment transaction by communicating with the external device 405 through magnetic stripe transmission, magnetic secure transmission, or NFC.

According to an embodiment of the present disclosure, the first device 401 may make a request to the server 403 such that the second device 402 may receive payment data originated from the first device 401, from the server 403. For example, the first device 401 may provide information on a payment card selected by the user and identification information of the second device 402 to the server 403. The server 403 may transmit payment data corresponding to information on the received payment card to a second device 402 specified by the received identification information through a network (e.g., a cellular network), via a specific authentication procedure. The second device 402 may perform a payment transaction with the external device 405 by using the payment data received from the server 403.

As illustrated in FIG. 4B, the second device 402 may acquire payment data originated from the first device 401 through various paths, and may use the payment data in a payment transaction. The payment transaction is made by the second device 402, but the payment data originated from the first device 401 is used. Accordingly, the legal effect of the payment transaction may belong to the user of the first device 401.

In the payment transaction, the first device 401 may be assumed to be a principal device, and the second device 402 may be assumed to be an agent device. Accordingly, the payment transaction may be referenced as an “agent payment”. The agent payment may be useful, for example, when a hardware configuration, such as contactless payment module (e.g., an MST module or an NFC module), for a contactless payment is not mounted on the first device 401 and the contactless payment module is mounted only on the second device 402.

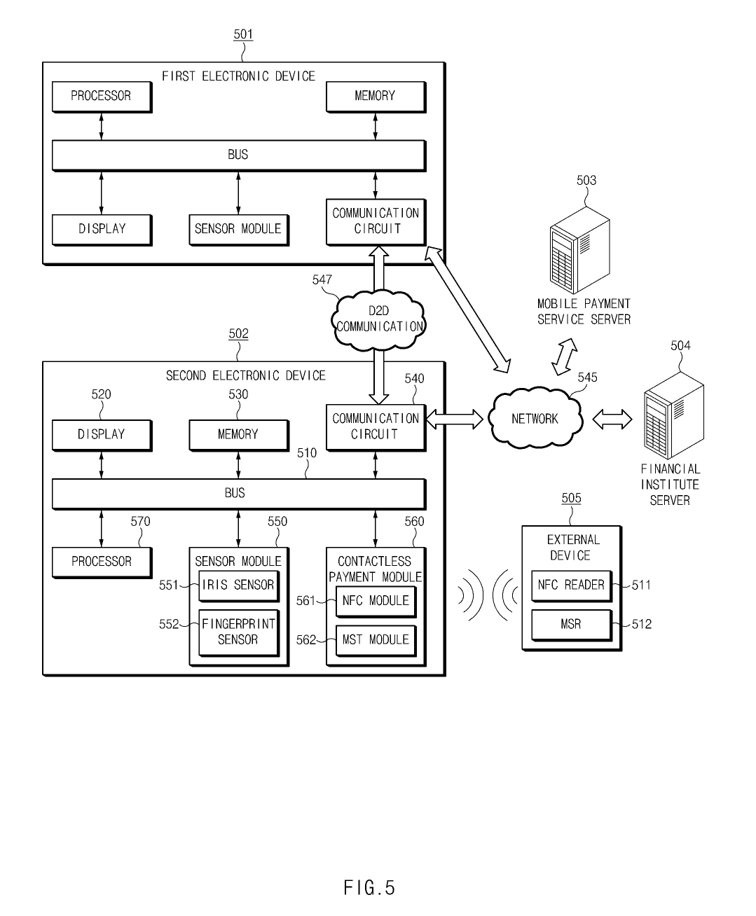

FIG. 5 illustrates of an electronic device according to an embodiment of the present disclosure.

Referring to FIG. 5, a payment method according to various embodiments of the present disclosure may be performed by a first electronic device 501, a second electronic device 502, a mobile payment service server 503, a financial institution server 504, and/or an external device 505. For example, the first electronic device 501, the second electronic device 502, the mobile payment service server 503, and the external device 505 may correspond to the first device 401, the second device 402, the server 403, and the external device 405, respectively.

The configuration of the first electronic device 501 may include a configuration that is the same as or similar to the second electronic device 502, except for a contactless payment module 560 of the second electronic device 502. Accordingly, the description of the configuration included in the first electronic device 501 will be replaced by the description of the second electronic device 502.

The second electronic device 502 may include a bus 510, a display 520, a memory 530, a communication circuit 540, a sensor module 550, the contactless payment module 560, and a processor 570. According to various embodiments of the present disclosure, some component configurations may be omitted from the second electronic device 502 or additional component configurations may be added to the second electronic device 502.

The bus 510 may electrically connect the elements 520 to 570 of the second electronic device 502. The bus may include a circuit that delivers communication messages (e.g., control messages and/or data) between the elements 520 to 570.

The display 520 may display various contents (e.g., a text, an image, a video, an icon, an object, or a symbol). The display 520 may include a touch screen and receive, for example, a touch, a gesture, a proximity, or a hovering input using an electronic pen or a part of the user's body.

The memory 530 may store commands, information, or data associated with operations of the elements 520 and 540 to 570 included in the second electronic device 502. For example, the memory 530 may store instructions that allow the processor 570 to perform various operations described in the present disclosure when executed on the processor 570. The instructions, for example, may be realized by software, such as an application program (e.g., a payment application or an agent payment application), an OS, or firmware to be stored in the memory or embedded in hardware.

According to various embodiments of the present disclosure, the memory 530 may be used as a security module (e.g., a security module 236). The security module may store information or data associated with a payment card. The security module, for example, may be realized by an SE, an eSE, a universal IC card (UICC), an embedded UICC (eUICC), a micro SD card, a SIM card, and a trust zone that is a storage or memory location that is protected from unauthenticated access.

The communication circuit 540 may include a wired and/or a wireless communication circuit. For example, the communication circuit 540 may include a wired and/or a wireless communication circuit for connection to a network (e.g., a cellular network or the Internet) 545 and a short range wireless communication circuit for a D2D communication connection 547. For example, a communication protocol used in the network 545 may include a cellular communication protocol, such as LTE, LTE-A, CDMA, WCDMA, UMTS, WiBro, or GSM, and Wi-Fi for connection to an access point. Further, the D2D communication connection 547 may include a communication connection using Bluetooth, an infrared ray communication protocol, BLE ZigBee, or Wi-Fi Direct.

According to an embodiment of the present disclosure, the communication circuit 540 of the second electronic device 502 may communicate with the first electronic device 501, the mobile payment service server 503, and/or the financial institution server 504, through the network 545. The communication circuit 540 of the second electronic device 02 may directly communicate with the first electronic device 501 through the D2D communication connection 547.

The sensor module 550 may measure or detect a physical quantity acquired in the interior of the electronic device 501 or in a surrounding environment of the second electronic device 502 through a specific interface to convert the physical quantity into an electrical signal. According to an embodiment of the present disclosure, the sensor module 550 may include a biometric sensor, such as an iris sensor 551 or a fingerprint sensor 552. The sensor module 550 may include various sensor modules including the sensor module 240.

According to an embodiment of the present disclosure, the iris sensor 551 or an iris recognition scanner may analyze wrinkles formed in the iris of the user, and may provide an analysis result to the processor 570. For example, the iris sensor 551 may include a light source for applying specific light (e.g., an infrared ray) to an iris of the user, a camera for capturing an iris image based on light reflected from the iris, and an image processing IC for analyzing and encoding a minutiae or pattern included in the iris image. The image processing IC may provide the analysis result to the processor 570. The camera for acquiring the iris image may correspond to an iris photographing dedicated (e.g., infrared ray) camera or a camera disposed on a front surface (e.g., where the display 520 is disposed) of the second electronic device 502.

The processor 570 may operate the light source and the camera included in the iris sensor 551 at a low frame rate first. If an image is acquired by the camera, the acquired image may be delivered to the image processing IC. The image processing IC may determine whether the face of the user exists in the delivered image. If the face of the user exists in the delivered image, the image processing IC may report the result to the processor 570. The processor 570 may operate the light source and the camera included in the iris sensor 551 at a high frame rate, and may perform an operation for the above-described recognition of the iris. The processor 570 may compare the recognized feature or pattern of the iris, and a feature or pattern (e.g., reference biometric information) of the iris stored or registered in the memory 530 in advance. The processor 570 may authenticate whether the iris having the recognized feature or pattern is an iris of the legal user based on the comparison result.

According to an embodiment of the present disclosure, the fingerprint sensor 552 may detect a fingerprint of the user. For example, a fingerprint image of a finger may be captured from the fingerprint sensor 552. The fingerprint sensor 552 may be classified into an optical type, an ultrasonic type, and a capacitive type according to the physical quantity used to acquire the fingerprint image. As another example, the fingerprint sensor 552 may be classified into an area type of recognizing a fingerprint in the unit of surfaces and a swipe type of recognizing a fingerprint in the unit of lines.

According to various embodiments of the present disclosure, an IC (such as a fingerprint sensor IC) included in or connected to the fingerprint sensor 552 may scan a specific fingerprint detection area. The fingerprint sensor IC may acquire a fingerprint image through scanning. The fingerprint sensor IC, for example, may extract a unique feature of the fingerprint from the fingerprint image. The fingerprint sensor IC may convert the extracted feature to a digital value, and may provide the converted value to the processor 570. For example, the extracted feature, that is, the fingerprint minutiae may include various feature points, such as a ridge ending, a crossover, a bifurcation, and a pore included in the fingerprint. The processor 570 may compare the extracted feature and a feature (e.g., reference biometric information) of the fingerprint stored or registered in the memory 530 in advance. The processor 570 may authenticate whether the detected fingerprint is a fingerprint of the legal user based on the comparison result.

The contactless payment module 560 may wirelessly transmit payment data to the external device 505. For example, the contactless payment module 560 may transmit the payment data to the external device 505 through a specific wireless channel (e.g., an NFC channel, or an MST channel). For example, the contactless payment module 560 may transmit the payment data stored in the memory 530 or received from the outside to the external device 505. According to an embodiment of the present disclosure, the payment data received from the outside may be payment data originating from the first electronic device 501.

Referring to FIG. 5, the contactless payment module 560 may be embedded in the second electronic device 502. According to various embodiments of the present disclosure, the contactless payment module 560 may be realized by a dedicated device or accessory and may be electrically coupled to the second electronic device 502 through a specific interface (e.g., a 3.5 mm earphone terminal, or a USB terminal).

According to an embodiment of the present disclosure, the contactless payment module 560 may include an NFC module 561 and an MST module 562. Although FIG. 5 illustrates that the contactless payment module 560 includes the NFC module 561 and the MST module 562, the present disclosure is not limited to the configuration of FIG. 5. For example, the contactless payment module 560 may include an RFID tag.

The NFC module 561, for example, may include an NFC controller or an NFC driver, and an RF module driven by the NFC controller. The NFC controller may convert payment data to an electrical signal, and may deliver the converted electrical signal to the RF module. The RF module, for example, may transmit the payment data or other data to the external device 505 in an electromagnetic induction mariner, or receive the payment data or other data from the external device 505, based on the electrical signal received from the NFC controller.

The MST module 562, for example, may include an MST controller or an MST driver, and an inductor driven by the MST controller. The MST controller may convert the payment data to an electrical signal (e.g., a pulse stream), and may deliver the converted electrical signal to the inductor. The inductor, for example, may generate a magnetic field fluctuation (e.g., a magnetic impulse) modulated in a specific manner based on the electrical signal received from the MST controller, and may transmit the payment data or other data to the external device 505 through the magnetic fluctuation. According to various embodiments of the present disclosure, the MST module 562 may be referenced as a magnetic secure transmission module or a magnetic stripe transmission module.

The processor 570 may be electrically connected to the elements 510 to 560 included in the electronic device 501 to execute calculations or data processing regarding control and/or communication of the elements 510 to 560 included in the electronic device 501.

According to an embodiment of the present disclosure the processor 570 may execute or launch an application for payment or agent payment. Various payment methods of the present disclosure may be performed through execution of the application.

According to an embodiment of the present disclosure, the processor 570 may receive the payment data originated from the first electronic device 501 through the communication circuit 540, and may transmit the received payment data to the external device 505 through the contactless payment module 560. The external device 505 may complete the corresponding payment transaction by using the payment data. If the is payment transaction is completed, information (e.g., a receipt) including a breakdown of the corresponding payment transaction may be transmitted to the first electronic device 501 and/or the second electronic device 502.

The above-described operation of the processor 570 is a simple example, and is not limited to the above description. For example, the operations of the second electronic device 502 described in the following parts of the present disclosure may be understood as operations of the processor 570. Further, in the present disclosure, at least some of the operations described as operations of “an electronic device” or “a server” may be understood as operations of the processor included in the corresponding device.

The mobile payment service server 503, for example, may receive information on a payment card received from the first electronic device 501, and may acquire payment data corresponding to the payment card through an interaction with the financial institution server 504. The mobile payment service server 503 may provide the payment data to the first electronic device 501 or the second electronic device 502 through the network 545.

The financial institution server 504 may be a server that is managed by a financial institution, such as a bank, a security company, a card company, or an insurance company. The financial institution server 504 may include a server (e.g., an OTT issuer server) that generates payment data. Although FIG. 5 illustrates only a single financial institution server 504, the number of the financial institution server 504 is not limited to a single server.

The external device 505, for example, may include a POS terminal provided in a merchant or an electronic device that may perform a person-to-person payment or remittance. The external device 505 may complete the corresponding payment transaction by using the payment data received from the second electronic device 502.

According to an embodiment of the present disclosure, the external device 505 may include a signal receiving module corresponding to the contactless payment module 560 of the second electronic device 502 to wirelessly transmit or receive payment data to or from the second electronic device 502. For example, the external device 505 may include an NFC reader 511 corresponding to the NFC module 561 of the second electronic device 502 and/or a magnetic stripe reader or magnetic secure reader 512 corresponding to the MST module 562 of the second electronic device 502. The external device 505 may, in addition to the above-described configurations, include a communication circuit for connection to a network and a processor for processing a payment transaction.

The NFC reader 511 may transmit and receive data on a payment transaction to and from the second electronic device 502 in an electromagnetic induction manner. For example, the NFC reader 511 may restore the payment data received from the NFC module 561 of the second electronic device 502 to an electrical signal, and may perform a payment transaction process based on the electrical signal.

The magnetic secure reader (MSR) 512 may receive data on the payment transaction by detecting the magnetic field fluctuation caused by the MST module 562 of the second electronic device 502. For example, the MSR 512 may restore the payment data received from the MST module 562 of the second electronic device 502 to an electrical signal, and may perform a payment transaction process based on the electrical signal.

According to an embodiment of the present disclosure, the external device 505 may complete a payment transaction by interacting with the mobile payment service server 503 and/or the financial institution server 504 through a network (e.g., a cellular network, a POS system network, or the Internet).

In the above-mentioned mobile payment environment, according to an embodiment of the present disclosure, the second electronic device 502 may receive the payment data originated from the first electronic device 501 from the mobile payment service server 503 through the network 545 (e.g., a cellular network). For example, if the first electronic device 501 transmits payment card information and identification information of the second electronic device 502 to the mobile payment service server 503, the mobile payment service server 503 may acquire payment data corresponding to the payment card information through an interaction with the financial institution server 504. The mobile payment service server 503 may transmit the acquired payment data to the second electronic device 502 specified by the identification information. The identification information, for example, may include at least one of a phone number, a mobile equipment identifier (MEID), an international mobile equipment identity (IMEI), and an international mobile subscriber identify (IMSI) of the second electronic device 502.

According to an embodiment of the present disclosure, when the payment data originated from the first electronic device 501 is transmitted from the mobile payment service server 503 to the second electronic device 502, various authentication procedures may be performed between any two of the first electronic device 501, the second electronic device 502, and/or the mobile payment service server 503.

For example, the authentication procedure may be performed by the mobile payment service server 503. For example, the mobile payment service server 503 may receive first authentication information (e.g., a password or an authentication code input by the user of the first electronic device 501) from the first electronic device 501, and may receive second authentication information (e.g., a password input by the user of the second electronic device 502) from the second electronic device 502. The mobile payment service server 503 may perform the authentication procedure by determining whether the first authentication information and the second authentication information coincide with each other. The mobile payment service server 503 may transmit the payment data to the second electronic device 502 in response to the success of the authentication procedure.

The authentication procedure may be made by the first electronic device 501. For example, the first electronic device 501 may acquire the first authentication information (e.g., a password) from the user of the first electronic device 501. Thereafter, the first electronic device 501 may receive the second authentication information input by the user of the second electronic device 502. The first electronic device 501 may perform the authentication procedure by determining whether the first authentication information and the second authentication information coincide with each other. The first electronic device 501 may transmit the payment card information and the identification information of the second electronic device 502 to the mobile payment service server 503 in response to the success of the authentication procedure. The mobile payment service server 503 may acquire payment data corresponding to the payment card information, and may transmit the acquired payment data to the second electronic device 502 specified by the identification information.

According to an embodiment of the present disclosure, the second electronic device 502 may directly receive the payment data originated from the first electronic device 501through the D2D communication connection 547. For example, the first electronic device 501 may receive payment data corresponding to the payment card information from the mobile payment service server 503, and may transmit the corresponding payment data to the second electronic device 502. When the first electronic device 501 directly transmits the payment data to the second electronic device 502 through the D2D communication connection 547, various authentication procedures may be performed between any two of the first electronic device 501, the second electronic device 502, and/or the mobile payment service server 503.

The authentication procedure may be performed by the mobile payment service server 503. For example, the first electronic device 501 may transmit the identification information about the second electronic device 502 to the mobile payment service server 503. The mobile payment service server 503 may perform an authentication procedure based on an interaction with the first electronic device 501 and the second electronic device 502 specified by the identification information. For example, the mobile payment service server 503 may receive first authentication information (e.g., a password input by the user of the first electronic device 501) from the first electronic device 501, receive second authentication information (e.g., a password input by the user of the second electronic device 502) from the second electronic device 502, and determine whether the first authentication information and the second authentication information coincide with each other to perform the authentication procedure.

If the authentication procedure is successful, the mobile payment service server 503 may transmit an authentication success message to the first electronic device 501 and/or the second electronic device 502. If receiving the authentication success message, the first electronic device 501 may transmit the payment data to the second electronic device 502.

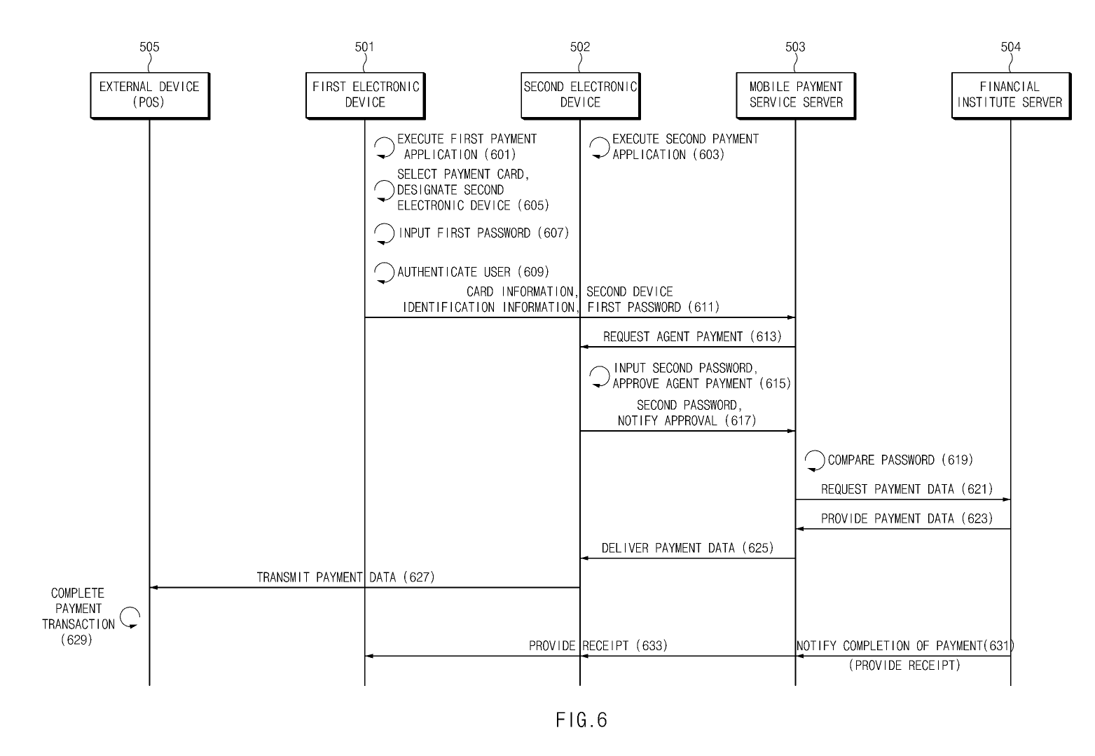

The authentication procedure may be made by the first electronic device 501. For example, the first electronic device 501 may acquire first authentication information (e.g., a password) from the user of the first electronic device 501, and may receive second authentication information input by the user of the second electronic device 502, from the second electronic device 502. The first electronic device 501 may perform the authentication procedure by determining whether the first authentication information and the second authentication information coincide with each other. The first electronic device 501 may transmit the payment data to the second electronic device 502 in response to the success of the authentication procedure FIG. 6 is a sequence diagram illustrating a payment method in which payment data is provided by a server and an authentication procedure is made by the server according to an embodiment of the present disclosure.

Referring to FIG. 6, a payment method according to an embodiment of the present disclosure may include operations 601 to 633. Operations 601 to 633, for example, may be performed by the devices and the servers 501 to 505. Operations 601 to 633, for example, may be realized by instructions that may be performed or executed by the devices and the servers 501 to 505. Hereinafter, the reference numerals of FIG. 5 are used in the description of operations 601 to 633, and a repeated description of FIG. 5 may be omitted.

In operation 601, the first electronic device 501 may execute or launch a first is payment application (e.g., agent payment application). The first application may include instructions for the operations performed by the first electronic device 501.

In operation 603, the second electronic device 502 may execute a second payment application (e.g., payment application). The second application may include instructions for the operations performed by the second electronic device 502.

In operation 605, the user of the first electronic device 501 may select a payment card by using a GUI from the first payment application output on the display of the first electronic device 501. Further, the user may designate the second electronic device 502 as an electronic device that will perform an agent payment by using the GUI. For example, the second electronic device 502 may be designated by the user, based on identification information (e.g., a phone number, an MEID, an IMEI, or an IMSI) of the second electronic device 502.

In operation 607, the user of the first electronic device 501 may input a password (e.g., the first authentication information) for an agent payment. The password input to the first electronic device 501 may be referenced as a first password.

In operation 609, the first electronic device 501 may perform a user authentication for processing of a payment. For example, the first electronic device 501 may authenticate the user by using an iris sensor or a fingerprint sensor. According to various embodiments of the present disclosure, the user authentication may be made through a personal identification number (PIN) authentication or an interaction with a principal authentication server such as a fast identity online (FIDO) server.

In operation 611, the first electronic device 501 may transmit information on the payment card selected in operation 605, the identification information of the second electronic device 502 designated in operation 605, and the first password acquired in operation 607, to the mobile payment service server 503. The first electronic device 501 may transmit a message that requests an agent payment, together with the information, to the mobile payment service server 503.

In operation 613, the mobile payment service server 503 may deliver an agent payment request message to the second electronic device 502 specified by the identification information received from the first electronic device 501. The agent payment request message is not limited by its title. For example, the agent payment request message may be a message that allows the second electronic device 502 to perform the following operations regardless of its form.

In operation 615, the user of the second electronic device 502 may input a password (e.g., the second authentication information) for an agent payment, and may approve the agent payment. The password input to the second electronic device 502 may be referenced as a second password.

In operation 617, the second electronic device 502 may deliver the second password input in operation 615 and an approval notification for the agent payment to the mobile payment service server 503.

In operation 619, the mobile payment service server 503 may compare the first password received in operation 611 and the second password received in operation 617 to determine whether the first password and the second password match each other. If the first password and the second password match each other, the process may proceed to operation 621, and otherwise, the agent payment process may not be completed.

In operation 621, because the first password and the second password match each other, the mobile payment service server 503 may request payment data from the financial institution server 504 based on the payment card information received in operation 611.

In operation 623, the financial institution server 504 may provide payment data corresponding to the payment card information to the mobile payment service server 503 in response to the request from the mobile payment service server 503.

In operation 625, the mobile payment service server 503 may deliver the payment data received from the financial institution server 504 to the second electronic device 502.

In operation 627, the second electronic device 502, for example, may transmit the payment data to the external device (e.g., a POS terminal) 505 in response to an input from the user. That is, the second electronic device 502 may perform a payment transaction with the external device 505 by using the payment data.

In operation 629, the external device 505 may complete the payment transaction by using the payment data received from the second electronic device 502.

In operation 631, the financial institution server 504 may notify the mobile payment service server 503 of the completion of the payment if the payment transaction is completed. Then, the notification of the completion of the payment may include a receipt of the corresponding payment transaction.

In operation 633, the mobile payment service server 503 may provide a receipt of the corresponding payment transaction received from the financial institution server 504 to the first electronic device 501 and/or the second electronic device 502.

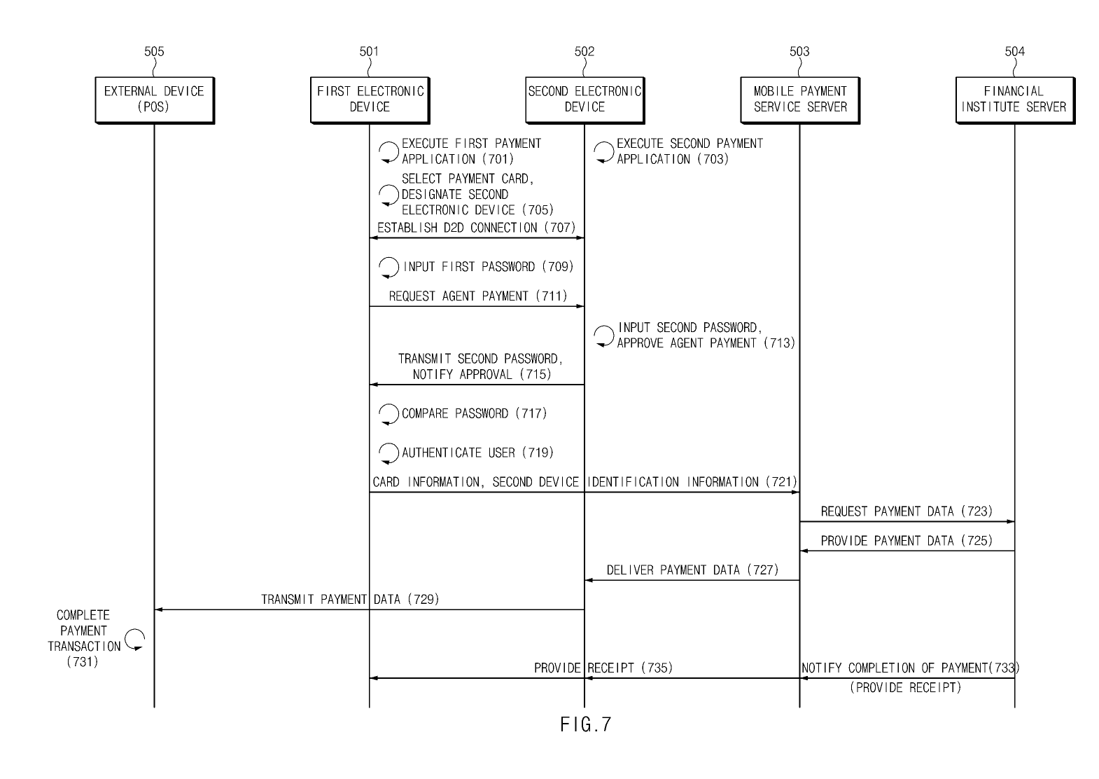

FIG. 7 is a sequence diagram illustrating a payment method in which payment data is provided by a server and an authentication procedure is made by a first electronic device according to an embodiment of the present disclosure.

Referring to FIG. 7, a payment method according to an embodiment of the present disclosure may include operations 701 to 735. Operations 701 to 735, for example, may be performed by the devices and the servers 501 to 505. Operations 701 to 735, for example, may be realized by instructions that may be performed or executed by the devices and the servers 501 to 505. Hereinafter, the reference numerals of FIG. 5 are used in the description of operations 701 to 735, and a repeated description of FIG. 6 may be omitted.

In operation 701, the first electronic device 501 may execute or launch a first payment application (e.g., agent payment application).

In operation 703, the second electronic device 502 may execute a second payment application (e.g., payment application).

In operation 705, the user of the first electronic device 501 may select a payment card by using a GUI of the first payment application output on the display of the first electronic device 501. Further, the user may designate the second electronic device 502 as an electronic device that will perform an agent payment, by using the GUI.

In operation 707, the first electronic device 501 may establish D2D communication with the second electronic device 502. For example, the D2D communication may include Bluetooth communication, infrared communication, or Wi-Fi Direct communication.

In operation 709, the first electronic device 501 may acquire a first password (e.g., the first authentication information) for an agent payment which has been input by the user.

In operation 711, the first electronic device 501 may transmit an agent payment request message to the second electronic device 502 designated in operation 705.

In operation 713, the user of the second electronic device 502 may input a second password (e.g., the second authentication information) for an agent payment, and may approve the agent payment.

In operation 715, the second electronic device 502 may deliver the second password input in operation 713 and an approval notification for the agent payment to the first electronic device 501.

In operation 717, the first electronic device 501 may compare the first password received in operation 709 and the second password received in operation 715 to determine whether the first password and the second password match each other. If the first password and the second password match each other, the process may proceed to operation 719, and the agent payment process may be completed.

In operation 719, the first electronic device 501 may perform a user authentication for processing of a payment. For example, the first electronic device 501 may authenticate the user by using an iris sensor or a fingerprint sensor.

In operation 721, the first electronic device 501 may transmit information on the payment card selected in operation 705 and the identification information of the second electronic device 502 designated in operation 705 to the mobile payment service server is 503.

In operation 723, the mobile payment service server 503 may request the payment data to the financial institution server 504 based on the payment card information received in operation 721.

In operation 725, the financial institution server 504 may provide the payment data corresponding to the payment card information to the mobile payment service server 503 in response to the request.

In operation 727, the mobile payment service server 503 may deliver the payment data received from the financial institution server 504 to the second electronic device 502.

In operation 729, the second electronic device 502, for example, may transmit the payment data to the external device (e.g., a POS terminal) 505 in response to an input from the user. That is, the second electronic device 502 may perform a payment transaction with the external device 505 by using the payment data.

In operation 731, the external device 505 may complete the payment transaction by using the payment data received from the second electronic device 502.

In operation 733, the financial institution server 504 may notify the mobile payment service server 503 of the completion of the payment if the payment transaction is completed. Then, the notification of the completion of the payment may include a receipt of the corresponding payment transaction.

In operation 735, the mobile payment service server 503 may provide a receipt of the corresponding payment transaction received from the financial institution server 504 to the first electronic device 501 and/or the second electronic device 502.

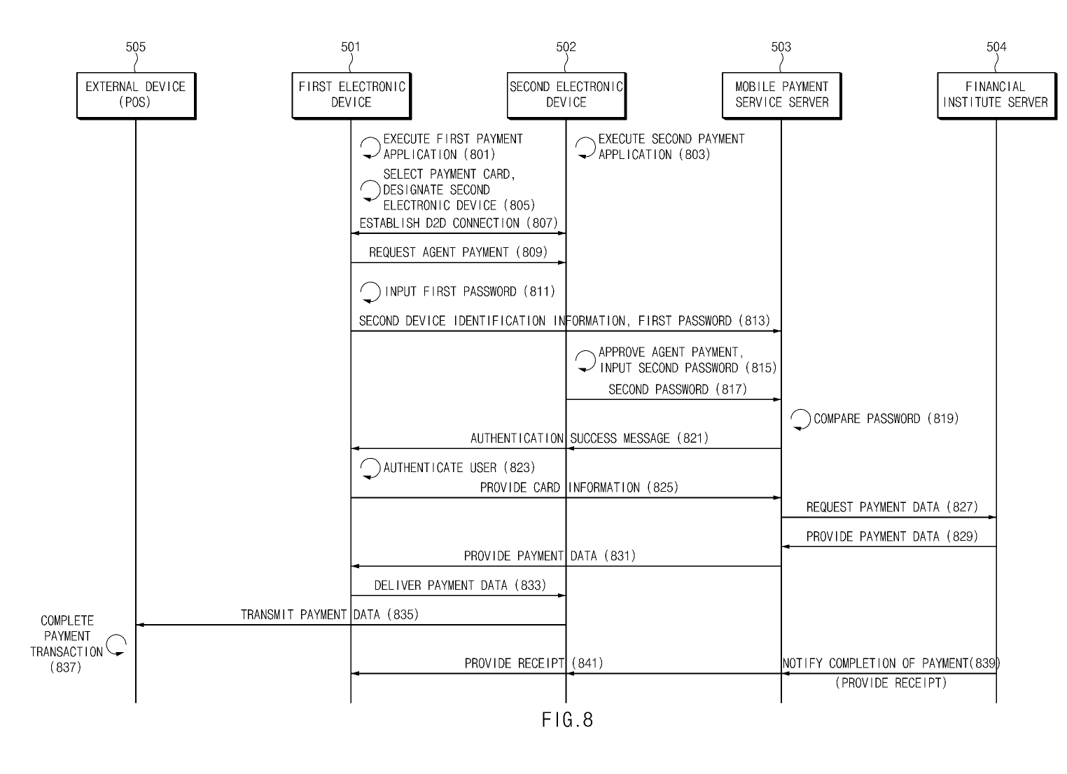

FIG. 8 is a sequence diagram illustrating a payment method in which payment data is provided by a first electronic device and an authentication procedure is made by a server according to an embodiment of the present disclosure.

Referring to FIG. 8, a payment method according to an embodiment of the present disclosure may include operations 801 to 841. Operations 801 to 841, for example, may be performed by the devices and the servers 501 to 505. Operations 801 to 841, for example, may be realized by instructions that may be performed or executed by the devices and the servers 501 to 505. Hereinafter, the reference numerals of FIG. 5 are used in the description of operations 801 to 841, and a repeated description of FIGS. 6 and 7 may be omitted.

In operation 801, the first electronic device 501 may execute or launch a first payment application (e.g., agent payment application).

In operation 803, the second electronic device 502 may execute a second payment application (e.g., payment application).

In operation 805, the user of the first electronic device 501 may select a payment card by using a GUI of the first payment application output on the display of the first electronic device 501. Further, the user may designate the second electronic device 502 as an electronic device that will perform an agent payment, by using the GUI.

In operation 807, the first electronic device 501 may establish D2D communication with the second electronic device 502.

In operation 809, the first electronic device 501 may transmit an agent payment request message to the second electronic device 502 designated in operation 805.

In operation 811, the first electronic device 501 may acquire a first password (e.g., the first authentication information) for an agent payment which has been input by the user.

In operation 813, the first electronic device 501 may transmit the identification information of the second electronic device 502 designated in operation 805 and the first password acquired in operation 811 to the mobile payment service server 503.

In operation 815, the user of the second electronic device 502 may input a second password (e.g., the second authentication information) for an agent payment, and may approve the agent payment in response to the request in operation 809.

In operation 817, the second electronic device 502 may transmit the second password input in operation 815 and an approval notification for the agent payment to the mobile payment service server 503.

In operation 819, the mobile payment service server 503 may compare the first password received in operation 813 and the second password received in operation 817 to determine whether the first password and the second password match each other. If the first password and the second password match each other, the process may proceed to operation 821, and the agent payment process may be completed.

In operation 821, because the first password and the second password match each other, the mobile payment service server 503 may transmit an authentication success message to the first electronic device 501 and the second electronic device 502. The authentication success message is not limited by its title. For example, the authentication success message may correspond to information/data that allows an agent payment regardless of its form.

In operation 823, the first electronic device 501 may perform a user authentication for processing of a payment if the authentication success message is received. For example, the first electronic device 501 may authenticate the user by using an iris sensor or a fingerprint sensor.

In operation 825, the first electronic device 501 may transmit information on the payment card selected in operation 805 to the mobile payment service server 503.

In operation 827, the mobile payment service server 503 may request the payment data to the financial institution server 504 based on the payment card information received in operation 825.

In operation 829, the financial institution server 504 may provide the payment data corresponding to the payment card information to the mobile payment service server 503 in response to the request.

In operation 831, the mobile payment service server 503 may provide the payment data received from the financial institution server 504 to the first electronic device 501.

In operation 833, the first electronic device 501 may deliver the payment data to the second electronic device 502 through D2D communication.

In operation 835, the second electronic device 502, for example, may transmit the payment data to the external device (e.g., a POS terminal) 505 in response to an input from the user. That is, the second electronic device 502 may perform a payment transaction with the external device 505 by using the payment data.

In operation 837, the external device 505 may complete the payment transaction by using the payment data received from the second electronic device 502.

In operation 839, the financial institution server 504 may notify the mobile payment service server 503 of the completion of the payment if the payment transaction is completed. Then, the notification of the completion of the payment may include a receipt of the corresponding payment transaction.

In operation 841, the mobile payment service server 503 may provide a receipt of the corresponding payment transaction received from the financial institution server 504 to the first electronic device 501 and/or the second electronic device 502.

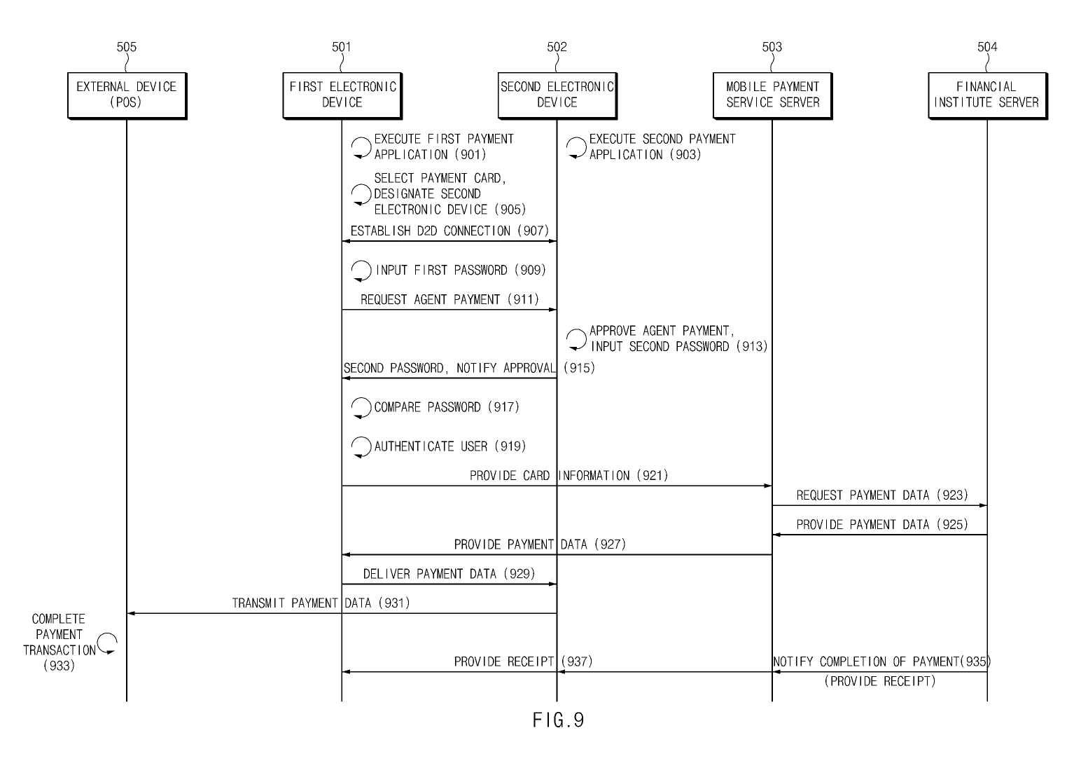

FIG. 9 is a sequence diagram illustrating a payment method in which payment data is provided by a first electronic device and an authentication procedure is made by the first electronic device according to an embodiment of the present disclosure.

Referring to FIG. 9, a payment method according to an embodiment of the present disclosure may include operations 901 to 937. Operations 901 to 937, for example, may be performed by the devices and the servers 501 to 505 illustrated in FIG. 5. Operations 901 to 937, for example, may be realized by instructions that may be performed or executed by the devices and the servers 501 to 505. Hereinafter, the reference numerals of FIG. 5 are used in the description of operations 901 to 937, and a repeated description of FIGS. 6 to 8 may be omitted.

In operation 901, the first electronic device 501 may execute or launch a first payment application (e.g., agent payment application).

In operation 903, the second electronic device 502 may execute a second payment application (e.g., payment application).

In operation 905, the user of the first electronic device 501 may select a payment card by using a GUI of the first payment application output on the display of the first electronic device 501. Further, the user may designate the second electronic device 502 as an electronic device that will perform an agent payment by using the GUI.

In operation 907, the first electronic device 501 may establish D2D communication with the second electronic device 502.

In operation 909, the first electronic device 501 may acquire a first password (e.g., the first authentication information) for an agent payment which has been input by the user.

In operation 911, the first electronic device 501 may transmit an agent payment request message to the second electronic device 502 designated in operation 905.

In operation 913, the user of the second electronic device 502 may input a second password (e.g., the second authentication information) for an agent payment, and may approve the agent payment in response to the request in operation 911.

In operation 915, the second electronic device 502 may transmit the second password input in operation 913 and an approval notification for the agent payment to the first electronic device 501.

In operation 917, the first electronic device 501 may compare the first password received in operation 909 and the second password received in operation 915 to determine whether the first password and the second password match each other. If the first password and the second password match each other, the process may proceed to operation 919, and otherwise, the agent payment process may not be completed.

In operation 919, because the first password and the second password match each other, the first electronic device 501 may perform a user authentication for processing a payment. For example, the first electronic device 501 may authenticate the user by using an iris sensor or a fingerprint sensor.

In operation 921, the first electronic device 501 may transmit information on the payment card selected in operation 905 to the mobile payment service server 503.

In operation 923, the mobile payment service server 503 may request the payment data to the financial institution server 504 based on the payment card information received in operation 921.

In operation 925, the financial institution server 504 may provide the payment data corresponding to the payment card information to the mobile payment service server 503 in response to the request.

In operation 927, the mobile payment service server 503 may provide the payment data received from the financial institution server 504 to the first electronic device 501.

In operation 929, the first electronic device 501 may deliver the payment data to the second electronic device 502 through D2D communication.

In operation 931, the second electronic device 502, for example, may transmit the payment data to the external device (e.g., a POS terminal) 505 in response to an input from the user. That is, the second electronic device 502 may perform a payment transaction with the external device 505 by using the payment data.

In operation 933, the external device 505 may complete the payment transaction by using the payment data received from the second electronic device 502.

In operation 935, the financial institution server 504 may notify the mobile payment service server 503 of the completion of the payment if the payment transaction is completed. Then, the notification of the completion of the payment may include a receipt of the corresponding payment transaction.

In operation 937, the mobile payment service server 503 may provide a receipt of the corresponding payment transaction received from the financial institution server 504 to the first electronic device 501.

According to various embodiment of the present disclosure, the first electronic device (e.g., principal device) may transmit its own payment data to the second electronic device through a server or directly, and the second electronic device may complete a payment by using the payment data originated from the first electronic device. Through this, even an electronic device not including a contactless payment module, such as an NFC module or an MST module, may perform mobile payment via another electronic device including a contactless payment module.

In accordance with an embodiment of the present disclosure, there is provided an electronic device including a communication circuit, a contactless payment module, a processor electrically connected to the communication circuit and the contactless payment module, and a memory electrically connected to the processor. The memory may store instructions to cause the processor to receive payment data originating from a second electronic device through the communication circuit, and transmit the payment data to an external device through the contactless payment module.

According to an embodiment of the present disclosure, the contactless payment module may include at least one of a magnetic stripe transmission module, a magnetic secure transmission module, and an NFC module.

According to an embodiment of the present disclosure, the communication circuit may be connected to a cellular network to communicate with a server, and the payment data originating from the second electronic device may be received from the server through the cellular network.

According to an embodiment of the present disclosure, the communication circuit may communicate with the second electronic device through device-to-device communication, and the payment data originating from the second electronic device may be received from the second electronic device through the device-to-device communication.

According to an embodiment of the present disclosure, the device-to-device communication may include at least one of Bluetooth communication, infrared ray communication, and Wi-Fi Direct communication.

According to an embodiment of the present disclosure, the payment data may include at least one of a PAN, a token, a OTT, and a cryptogram obtained by replacing at least a part of the PAN of a payment card. The payment data may include at least one of a token, a token reference ID, a part of a PAN, a PAN product ID, a token requester ID, a token assurance level, token assurance data, an expiration date of a token, a token cryptogram, an entry mode, and a token requestor indicator.

According to an embodiment of the present disclosure, the external device may include a signal receiving module corresponding to the contactless payment module.

In accordance with another aspect of the present disclosure, there is provided a payment method including transmitting card information and identification information of a second device to a server, by a first device, transmitting payment data corresponding to the card information to the second device specified by the identification information, by the server, and performing a payment transaction with an external device by using the payment data, by the second device.

According to an embodiment of the present disclosure, transmitting the card information and the identification information of the second device by the first device may be performed in response to a success of an authentication procedure.

According to an embodiment of the present disclosure, the designated authentication procedure may include acquiring first authentication information, by the first device, receiving second authentication information from the second device, by the first device, and determining whether the first authentication information and the second authentication information match each other by the first device.

According to an embodiment of the present disclosure, the first authentication information and the second authentication information may include a password.

According to an embodiment of the present disclosure, transmitting the payment data to the second device by the server may be performed in response to a success of an authentication procedure.

According to an embodiment of the present disclosure, the designated authentication procedure may include receiving a first authentication information from the first device, by the server, receiving a second authentication information from the second device, by the server, and determining whether the first authentication information and the second authentication information match each other by the first device.

According to an embodiment of the present disclosure, the payment method may further include transmitting information including a breakdown of the payment transaction to at least one of the first device and the second device.

According to an embodiment of the present disclosure, the identification information may include at least one of a phone number, a MEID, an IMEI, and an IMSI.

In accordance with an aspect of the present disclosure, there is provided a payment method including receiving payment data corresponding to card information from a server, by a first device, transmitting identification information of a second device to the server, by the first device, performing an authentication procedure based on an interaction between the first device and the second device, by the server, if the authentication procedure is successful, transmitting an authentication success message to the first device and the second device, by the server, if the authentication success message is received, transmitting the payment data to the second device, by the first device, and performing a payment transaction with an external device by using the payment data, by the second device.

According to an embodiment of the present disclosure, the designated authentication procedure may include transmitting first authentication information to the server, by the first device, transmitting second authentication information to the server, by the second device, and determining whether the first authentication information and the second authentication information match each other by the first device.

According to an embodiment of the present disclosure, the first device may transmit the payment data to the second device through device-to-device communication.

According to an embodiment of the present disclosure, the device-to-device communication may include at least one of Bluetooth communication, infrared ray communication, and Wi-Fi Direct communication.

According to an embodiment of the present disclosure, the second device may perform the payment transaction by communicating with the external device through at least one of magnetic stripe transmission, magnetic secure transmission, and near field communication (NFC).

The term “module” used in the present disclosure may represent, for example, a unit including one or more combinations of hardware, software and firmware. The term “module” may be interchangeably used with the terms “unit”, “logic”, “logical block”, “component”, and “circuit”. The “module” may be a minimum unit of an integrated component or may be a part thereof The “module” may be a minimum unit for performing one or more functions or a part thereof The “module” may be implemented mechanically or electronically. For example, the “module” may include at least one of an application specific integrated circuit (ASIC) chip, a field programmable gate array (FPGA), and a programmable logic device for performing some operations, which are known or will be developed.

At least a part of an apparatus (e.g., modules or functions thereof) or a method (e.g., operations) according to various embodiments of the present disclosure may be, for example, implemented by instructions stored in computer-readable storage media in the form of a program module. The instruction, when executed by a processor (e.g., the processor 120), may cause the one or more processors to perform a function corresponding to the instruction. The computer-readable storage media, for example, may be the memory 130.

A computer-readable recording medium may include a hard disk, a floppy disk, a magnetic media (e.g., a magnetic tape), an optical media (e.g., a compact disc read only memory (CD-ROM) and a DVD, a magneto-optical media (e.g., a floptical disk)), and hardware devices (e.g., a read only memory, a random access memory, or a flash memory). Also, a program instruction may include not only a assembly code such as things generated by a compiler but also a high-level language code executable on a computer using an interpreter. The above hardware unit may be configured to operate via one or more software modules for performing an operation of various embodiments of the present disclosure, and vice versa.

A module or a program module according to various embodiments of the present disclosure may include at least one of the above elements, or a part of the above elements may be omitted, or additional other elements may be further included. Operations performed by a module, a program module, or other elements may be executed sequentially, in parallel, repeatedly, or in a heuristic method. In addition, some operations may be executed in different sequences or may be omitted. Alternatively, other operations may be added.

While the present disclosure has been shown and described with reference to various embodiments of the present disclosure thereof, it will be understood by those skilled in the art that various changes in form and details may be made therein without departing from the spirit and scope of the present disclosure as defined by the appended claims and their equivalents.

What is claimed is:

1. An electronic device, comprising:
a communication circuit;
a contactless payment module;
a processor electrically connected to the communication circuit and the contactless payment module; and
a memory electrically connected to the processor,
wherein the memory stores instructions to cause the processor to:
receive payment data originating from another electronic device through the communication circuit; and
transmit the payment data to an external device through the contactless payment module.

2. The electronic device of claim 1, wherein the contactless payment module includes at least one of a magnetic stripe transmission module, a magnetic secure transmission module, and a near field communication (NFC) module.

3. The electronic device of claim 1, wherein the communication circuit is connected to a cellular network to communicate with a server, and
wherein the payment data originating from the another electronic device is received from the server through the cellular network.

4. The electronic device of claim 1, wherein the communication circuit communicates with the another electronic device through device-to-device communication, and
wherein the payment data originating from the another electronic device is received from the another electronic device through the device-to-device communication.

5. The electronic device of claim 4, wherein the device-to-device communication includes at least one of Bluetooth communication, infrared ray communication, and Wi-Fi Direct communication.

6. The electronic device of claim 1, wherein the payment data includes at least one of a primary account number (PAN), a token, a one-time token (OTT), and a cryptogram obtained by replacing at least a part of the PAN of a payment card.

7. The electronic device of claim 1, wherein the external device includes a signal receiving module corresponding to the contactless payment module.

8. A payment method, comprising:
transmitting card information and identification information of a second device to a server by a first device;
transmitting payment data corresponding to the card information to the second device specified by the identification information by the server; and
performing a payment transaction with an external device by using the payment data by the second device.

9. The payment method of claim 8, wherein transmitting the card information and the identification information of the second device by the first device is performed in response to a success of an authentication procedure.

10. The payment method of claim 9, wherein the authentication procedure includes:
acquiring a first authentication information by the first device;
receiving a second authentication information from the second device by the first device; and
determining whether the first authentication information and the second authentication information match each other by the first device.

11. The payment method of claim 10, wherein the first authentication information and the second authentication information include a password.

12. The payment method of claim 8, wherein transmitting the payment data to the second device by the server is performed in response to a success of an authentication procedure.

13. The payment method of claim 12, wherein the authentication procedure includes:
receiving a first authentication information from the first device by the server;
is receiving a second authentication information from the second device by the server; and
determining whether the first authentication information and the second authentication information match each other by the first device.

14. The payment method of claim 8, further comprising:
transmitting information including a breakdown of the payment transaction to at least one of the first device and the second device.

15. The payment method of claim 8, wherein the identification information includes at least one of a phone number, a mobile equipment identifier (MEID), an international mobile equipment identity (IMEI), and an international mobile subscriber identity (IMSI).

16. A payment method, comprising:
receiving payment data corresponding to card information from a server by a first device;
transmitting identification information of a second device to the server by the first device;
performing an authentication procedure based on an interaction between the first device and the second device by the server;
if the authentication procedure is successful, transmitting an authentication success message to the first device and the second device by the server;
if the authentication success message is received, transmitting the payment data to the second device by the first device; and
performing a payment transaction with an external device by using the payment data by the second device.

17. The payment method of claim 16, wherein the authentication procedure includes:
transmitting a first authentication information to the server by the first device;
transmitting a second authentication information to the server by the second device; and
determining whether the first authentication information and the second authentication information match each other by the first device.

18. The payment method of claim 16, wherein the first device transmits the payment data to the second device through device-to-device communication.

19. The payment method of claim 18, wherein the device-to-device communication includes at least one of Bluetooth communication, infrared ray communication, and Wi-Fi Direct communication.

20. The payment method of claim 16, wherein the second device performs the payment transaction by communicating with the external device through at least one of magnetic stripe transmission, magnetic secure transmission, and near field communication (NFC).
